(19) United States
(12) Patent Application Publication
(10) Pub. No.: US 2010/0225174 A1
(43) Pub. Date: Sep. 9, 2010

(54) Wireless Power Transfer Using Magnets

(76) Inventor: Hao Jiang, San Francisco, CA (US)

Correspondence Address: DAVIS WRIGHT TREMAINE LLP - San Francisco, 505 MONTGOMERY STREET, SUITE 800, SAN FRANCISCO, CA, 94111, US

(21) Appl. No.: 12/718,825

(22) Filed: Mar. 5, 2010

Related U.S. Application Data
(60) Provisional application No. 61/209,211, filed on Mar. 5, 2009.

(51) Int. Cl. H01F 38/14

(52) U.S. Cl. 307/104

(57) ABSTRACT

A wireless power transfer scheme is disclosed with moving permanent magnets for inducing current in conductive coils. Preferably the magnets are rotated about a line that is perpendicular or parallel to the axis of the coils to deliver substantial power at low frequencies. In one embodiment, three phase power may be so delivered. The technique may be used for powering medical implants and nanoelectronic circuits.

### CROSS-REFERENCE TO RELATED APPLICATIONS

This application claims priority to U.S. Provisional patent application No. 61/209,211 dated Mar. 5, 2009 entitled “Wireless Power Transfer Using Magnets.”

### BACKGROUND

The present invention is in the technical field of electrical engineering. More particularly, the present invention is in the technical field of wireless/contactless electrical power/energy transfer.

There are two approaches for wireless power transmission that have been proposed so far. The first approach is to rectify the received signal from the antenna directly; this approach usually is for far-field (the transferring distance is much larger than the wavelength of the signal) wireless power transfer. The second approach delivers the power between two or multiple inductive coils like a transformer but without the ferrite core, and is used for near field applications, where the transferring distance is much smaller than the wavelength of the signal. These approaches are described, for example, in Ko et al., Design of Radio-Frequency Powered Coils for Implant Instruments, Med. & Biol. Eng. & Comput., 1977, 15, 634-640, and in Jow, Design and Optimization of Printed Spiral Coils for Efficient Transcutaneous Inductive Power Transmission, IEEE Transactions on Biomedical Circuits and Systems, Vol. 1, No. 3, September 2007.

These approaches are disadvantageous because they are plagued by many problems. For example, the second approach employing power transfer by induction between two or multiple inductive coils are highly sensitive to lateral and angular misalignment between the inductive coils. Moreover, in order to deliver enough power, the operating frequency of currents in these coils are in the megahertz range. This causes interference with transmission of information signals. When used in implants in a living being such as an animal or human body, body tissue severely attenuates the power delivered by the coils, and also severely limits the use of this technique. It is therefore desirable to provide improved techniques where these disadvantages are overcome.

### SUMMARY

This invention provides an effective solution to transfer the electrical power wirelessly. It can be used to power up electrical circuits and apparatus that do not have a power source (e.g. a battery) without any physical connection. Wireless electrical power transfer is critical in applications like biomedical implantable devices, radio frequency identification (RFID) systems and nano scale electronics.

One embodiment of the invention is used for supplying power to a medical device to be implanted in a living being, and comprises a coil located in or near the medical device, and at least one permanent magnet located adjacent to said coil. A mechanism is used for moving said at least one permanent magnet relative to the coil to induce a current in the coil. Preferably, the mechanism comprises a motor for rotating said at least one permanent magnet about a line.

Another embodiment of the invention is used for supplying power to an electronic circuit, and comprises a coil located in or near the circuit, and at least one permanent magnet located adjacent to said coil. A mechanism is used for moving said at least one permanent magnet relative to the coil to induce a current in the coil. Preferably, the mechanism comprises a motor for rotating said at least one permanent magnet about a line.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF DRAWINGS

FIG. 1A is a perspective view of a wireless power transfer scheme of the present invention to illustrate one embodiment of the invention. L_{R} is the receiving inductor coil, R_{L} is the loading resistance.

FIG. 1B is a perspective view of a permanent magnet that is rotated about a line relative to three different positions of a coil useful for illustrating aspects of the invention.

FIG. 2 is a schematic view of six permanent magnets rotated about a line adjacent to a coil to illustrate another embodiment of the invention.

FIGS. 3A, 3B and 3C are schematic views of three different wireless power transfer schemes to illustrate three different embodiments of the invention.

FIG. 4 is a graphical plot of the power delivered by the three different wireless power transfer schemes of FIGS. 3A, 3B and 3C in relation to some of the conventional schemes that have been proposed.

FIG. 5 is a schematic view of wireless power transfer scheme to illustrate the effect of lateral displacement between the permanent magnet and coil to illustrate an advantage of one embodiment of the invention.

FIG. 6 is a graphical plot of the power delivered by the three different wireless power transfer schemes of FIGS. 3A, 3B and 3C where there is a lateral displacement between the permanent magnet and coil to illustrate the effect of such displacement on the delivered power.

FIG. 7 is a schematic view of wireless power transfer scheme to illustrate yet another embodiment of the invention.

FIGS. 8A and 8B are schematic views of six permanent magnets and six coils distributed around a circle for illustrating the embodiment of FIG. 7.

FIGS. 9A, 9B and 9C are schematic views of three layers of coils to be used as a modification of the scheme of FIG. 7 as shown in solid and broken lines to illustrate still another embodiment of the invention.

FIG. 10 is a circuit diagram showing how the coils in each of the three layers of coils of FIGS. 9A, 9B and 9C are electrically connected.

FIG. 11 is a schematic view of a human body with a medical device implant, which includes or is close to a coil, and a rotating permanent magnet to illustrate one application of one embodiment of the invention.

FIG. 12 is a schematic view of a nano-circuit, a coil adjacent to the nano-circuit and a rotating permanent magnet to illustrate another application of one embodiment of the invention.

Identical components in this application are labeled by the same numerals.

### DETAILED DESCRIPTION OF EXEMPLARY EMBODIMENTS

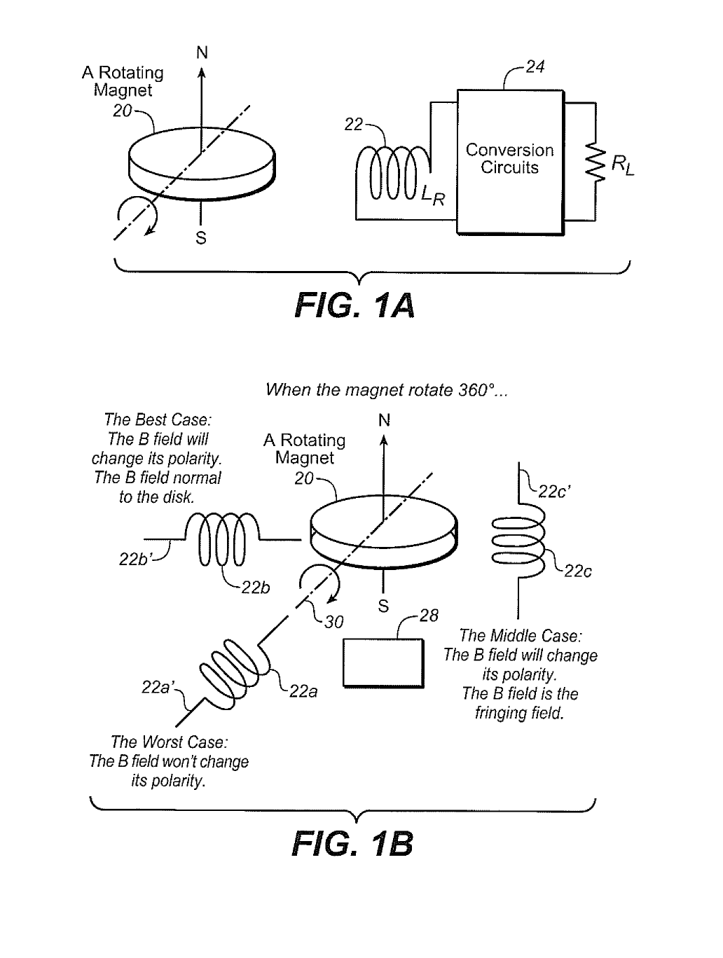

The basic components of this invention are a rotating magnet 20 and a inductor coil 22, which may be arranged in a number of configurations, one of which is as shown in FIG. 1A. The rotating magnet generates time-varying magnetic field. The inductor coil picks up the time-varying magnetic field and converts the time varying magnetic field into electrical voltage. The coil has inductance L_{R}, and R_{L} is the loading resistance, where conversion circuits 24 converts the voltage generated by the coil into useful current to load R_{L}. Thus, the mechanical power, which drives the rotation of the magnet, is converted into the electrical power wirelessly.

The geometrical configuration of the magnet and the receiving inductive coil is illustrated in FIG. 1A. When the magnet and the inductor coil are face to face (that is when the circular plane surface of the magnet 20 is parallel to the rounds of the coil 22), the magnetic field lines that perpendicularly pass through the cross-section of the inductive coil reach the maximum. When the magnet rotates 180°, the magnetic field inside the receiving coil changes direction completely. Therefore, the receiving coil experiences the maximum variation of the magnetic field that is perpendicular to its cross section when the magnet rotates. The Faraday's law is still applied here to convert the time-varying magnetic field that is generated by the moving magnet into the electrical voltage. Thus, electrical power is delivered wirelessly via the rotating magnet.

The advantages of the present invention include, without limitation, are that this method can deliver much larger power wireless because the rare-earth magnet is able to generate far more stronger magnetic field than any inductive coils with reasonable amount current; This invention will allow the wireless power transfer to operate at low frequency. In addition, a ferrite core can be used in the receiving inductive coil to improve the coupling efficiency. When the coil is employed to power medical implants, the electroabsorption of human body tissue can be avoided. Moreover, the interference between the power transfer and data communication can be avoided.

FIG. 1B is a perspective view of a permanent magnet 20 that is rotated by a motor 28 about a line 30 relative to three different positions 22a, 22b, 22c of a coil useful for illustrating aspects of the invention. Where the magnet is rotated about line 30 that coincides with the axis 22a′ of the coil where the coil is at position 22a, the coil does not experience any change in the magnetic field despite rotation of the magnet, so that this is the worse relative positions of the coil and magnet. Where the magnet is rotated about line 30 that is substantially perpendicular to the axis 22b′ of the coil where the coil is at position 22b, the coil experiences the maximum change in the magnetic field as a result of rotation of the magnet, so that this is the one of the best relative positions of the coil and magnet. Where the magnet is rotated about line 30 that is laterally displaced from axis 22c′ of the coil where the coil is at position 22c, the coil experiences an intermediate change in the magnetic field as a result of rotation of the magnet, so that this is the one of the operable relative positions of the coil and magnet. As illustrated below, it is also possible to orient the permanent magnet 20 and coil so that the magnet is rotated about line 30 that is substantially parallel to but laterally displaced from the axis of the coil, which configuration is also useful for delivering power wirelessly.

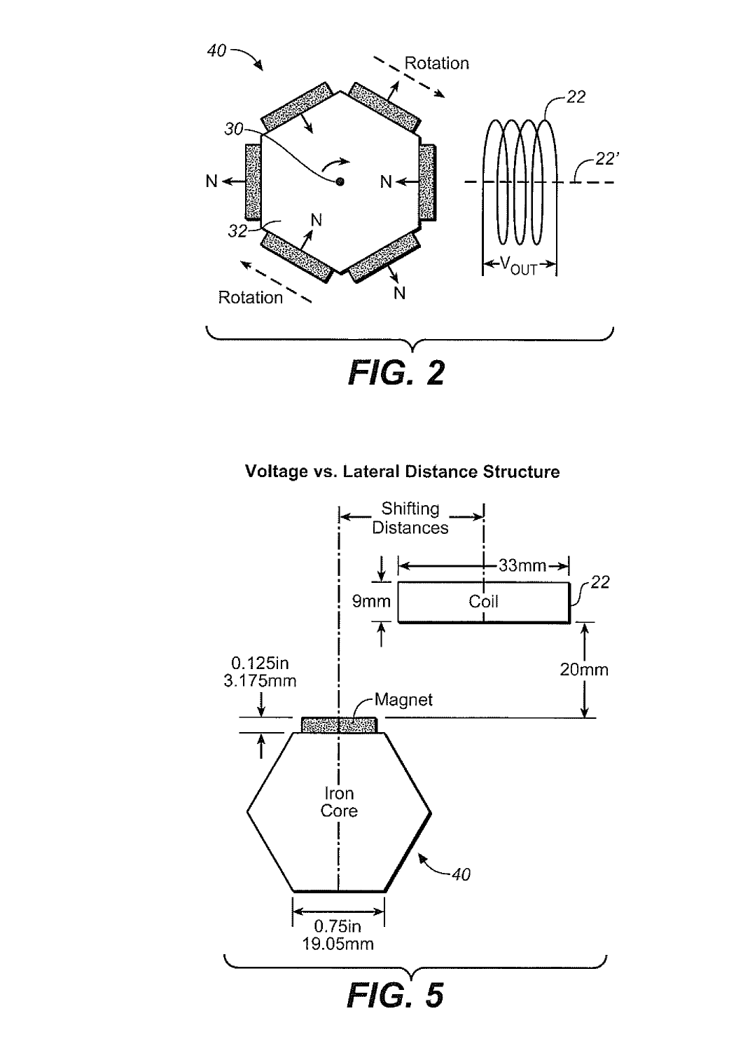

FIG. 2 is a schematic view of six permanent magnets, rotated about a line 30, adjacent to a coil 22 to illustrate another embodiment of the invention. The six permanent magnets 20a, 20b, 20c, 20d, 20e and 20f are mounted on the six flat side surfaces of a hexagonal shaped (instead of cylindrical shaped) rotor 32 with the surface perpendicular to the line 30 hexagonal in shape to form a rotor-magnet assembly 40. The rotor is rotated about a line 30 perpendicular to the page of the figure along arrow 42, where line 30 is substantially perpendicular to axis 22′ of coil 22. As noted in FIG. 2, the arrows pointing out from the magnets indicate the North pole direction of the magnets. As shown in FIG. 2, magnets with the North pole direction pointing away from line 30 are separated by magnets whose North pole direction point towards line 30. Instead of a hexagonal shaped rotor, other polygonal rotors may also be used, such as cubical, octagonal and rotors with other polygonal shapes with even number of sides. Preferably, the diameter of the coil is greater than the largest dimension of the one or more permanent magnets, such as by at least 10%. Preferably, with other polygonal rotor designs, the number of coils is equal to the number of permanent magnets, and the coils are distributed in a manner similar to distribution of the permanent magnets on the substantially planar polygonal surface. Also preferably, the permanent magnets are arranged along a circle on said substantially planar polygonal surface, with adjacent ones of the said permanent magnets around the circle oriented with opposite polarities.

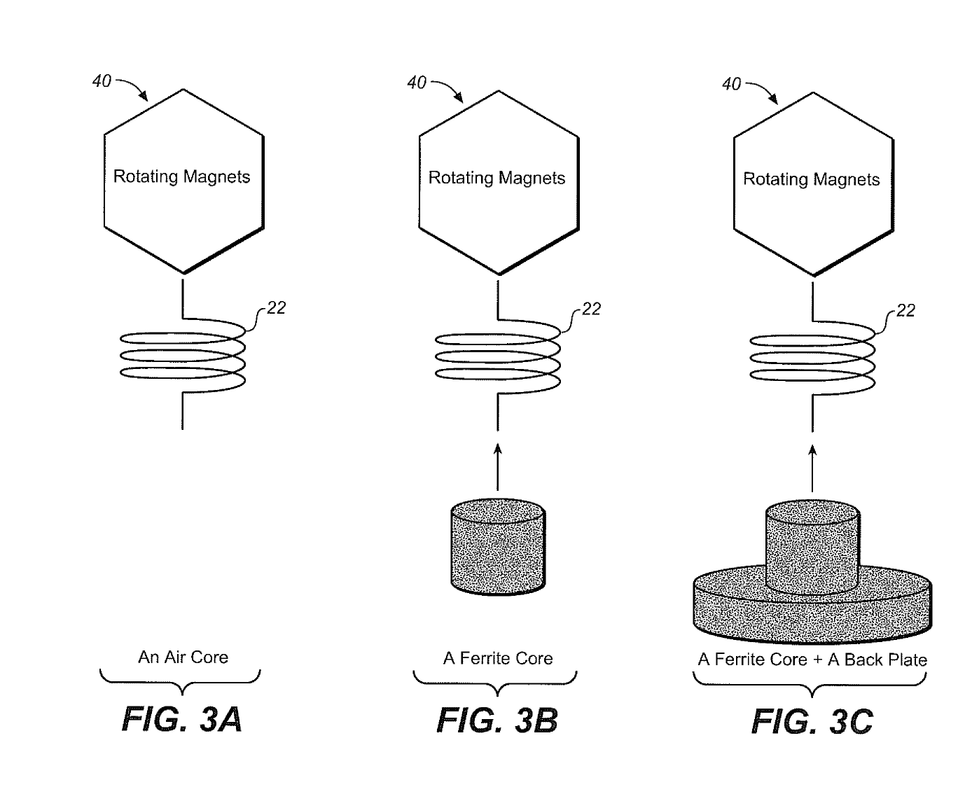

FIGS. 3A, 3B and 3C are schematic views of three different wireless power transfer schemes to illustrate three different embodiments of the invention. FIG. 3A shows a configuration discussed above in reference to FIG. 2. The configuration of FIG. 3B differs from the configuration of FIG. 3A in that the configuration of FIG. 3B employs a coil with a ferrite core, whereas there is no such core in the coil of FIG. 3A. The presence of the core increases the power effectively delivered to the coil, when the coil experiences the same changes in magnetic field as that in FIG. 3A. The presence of a back plate element made of a high magnetic permeability material in addition to the ferrite core further increases the power effectively delivered to the coil.

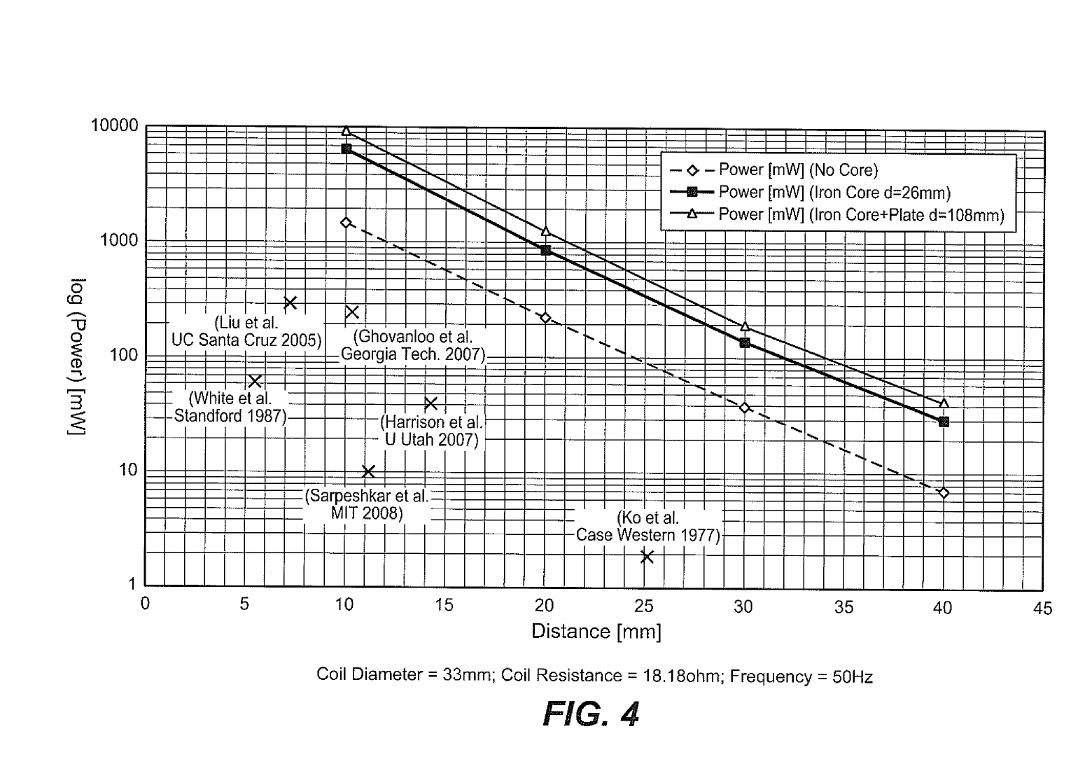

FIG. 4 is a graphical plot of the power delivered by the three different wireless power transfer schemes of FIGS. 3A, 3B and 3C in relation to some of the conventional schemes that have been proposed. The power delivered by each of six conventional schemes are indicated on the plot, where the power delivered by a particular conventional scheme is labeled with respect to the paper that describes such scheme. Thus, four of the six conventional schemes are described in the four papers below:

(1) Liu et al at UC Santa Cruz:

G. Wang, W. Liu, M. Sivaprakasam, and G. A. Kendir, “Design and analysis of an adaptive transcutaneous power telemetry for biomedical implants,” IEEE Trans. on Circuits Syst. I, Reg. Papers, vol. 52, no. 10, pp. 2109-2117, October, 2005;

(2) White et al at Stanford University:

D. C. Galbraith, M. Soma and R. L. White, “A wide-band e_cient inductive transdermal power and data link with coupling insensitive gain”, IEEE Trans. Bio. Eng., vol. 34, no. 4, pp. 265-275, April, 1987;

(3) Sarpeshkar et al. MIT 2008:

S. Mandal and R. Sarpeshkar, “Power-e_cient impedance-modulation wireless data links for biomedical implants”, IEEE Trans. Biomed. Circuits Syst., vol. 2, no. 4, pp. 301-315, December, 2008

(4) Ghovanloo et al. Georgia Tech. 2007:

M. Ghovanloo and S. Atluri, “A wide-band power-e_cient inductive wireless link for implantable microelectronic devices using multiple carriers,” IEEE Trans. on Circuits Syst. I, Reg. Papers, vol. 54, no. 10, pp. 2211-2220, October, 2007.

(5) Harrison et al. U Utah 2007

R. R. Harrison, P. T. Watkins, R. Kier, R. Lovejoy, D. Black, R. Normann, and F. Solzbacher “Low-power integrated circuit for a wireless 100-electrode neural recording system”, IEEE J. Solid-State Circuits, vol. 42, no. 1, pp. 123-133, January, 2007

(6) Ko et al. Case Western 1977

W. H. Ko, S. P. Liang, and C. D. F. Fung, “Design of radio-frequency powered coils for implant instruments,”, Med. & Biol. Eng. & Comput., vol. 15, pp. 634-640, 1977

As shown in FIG. 4, the different wireless power transfer schemes of FIGS. 3A, 3B and 3C are all superior to the conventional techniques in deliver power in a wireless manner. The motor 28 may be rotated at a slow speed, so that rotation of the one or more permanent magnets induces a current in the coil having a frequency of not more than 1 KHz. Hence, even at relatively low frequencies such as below 1 KHz, greater power is delivered in a wireless manner to the coil than conventional techniques. This allows the low frequency power to achieve much better penetration of tissue of a living being such as a human or other kinds of animal body, and will be less likely to interfere with communication signals from the implanted device to the outside world.

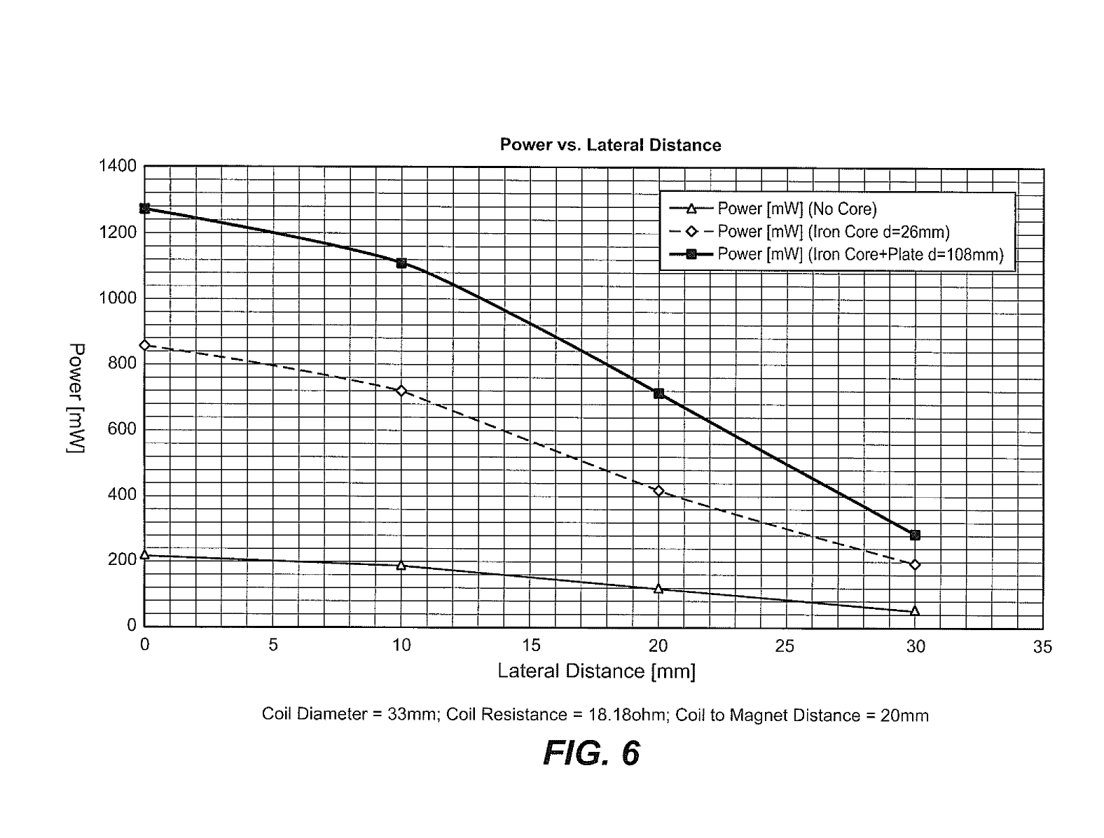

FIG. 5 is a schematic view of wireless power transfer scheme to illustrate the effect of lateral displacement between the permanent magnet and coil to illustrate an advantage of one embodiment of the invention. Shown in FIG. 5 are the dimensions of assembly 40 of FIG. 2, and of coil 22, and the separation of 20 mm between them, with a variable relative lateral displacement between them. FIG. 6 is a graphical plot of the power delivered by the three different wireless power transfer schemes of FIGS. 3A, 3B and 3C using the assembly and coil dimensions and spatial arrangement as shown in FIG. 5, to show the influence of the magnitude of the lateral displacement between the permanent magnet and coil on the power delivered to the coil. As illustrated in FIG. 6, the power delivered falls off very gradually with increase in the lateral displacement, especially within a tolerance of ±5 mm. Thus the wireless power transfer schemes of FIGS. 3A, 3B and 3C are very robust and tolerant of lateral displacement between the permanent magnet and coil on the power delivered to the coil.

FIG. 7 is a schematic view of wireless power transfer scheme to illustrate yet another embodiment of the invention. In this embodiment, the multiple magnets 120 are mounted on a (preferably substantially flat) surface 104 of a plate 102 that is perpendicular to the line 30 about which the surface is rotated by motor 28. A number of coils 122 are arranged to form a layer 122a that is substantially parallel to surface 104. Preferably, coils 122 are mounted into a (preferably substantially flat) surface 108 of a non-conductive dielectric plate 106 as shown in FIG. 7, where surface 108 is substantially parallel to surface 104. This embodiment is advantageous in that the coils can be located very close to the magnets, thereby increasing the coupling efficiency between them. In this case, the rotation of the magnets is about line 30 which is substantially parallel to the axes 122′ of the coils 122.

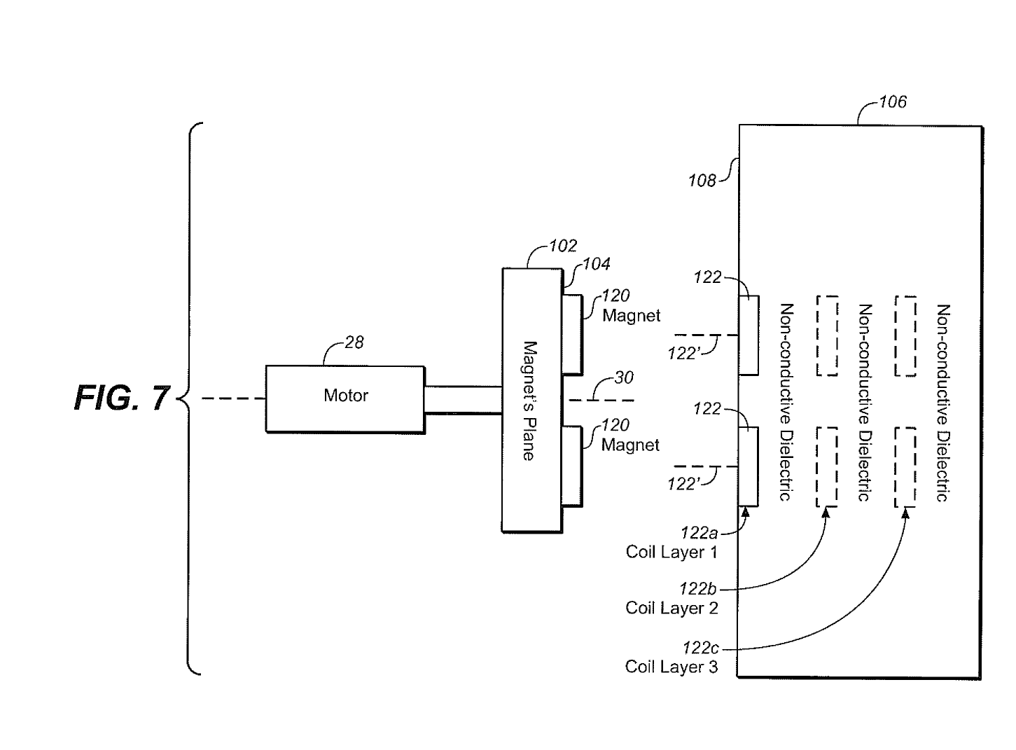

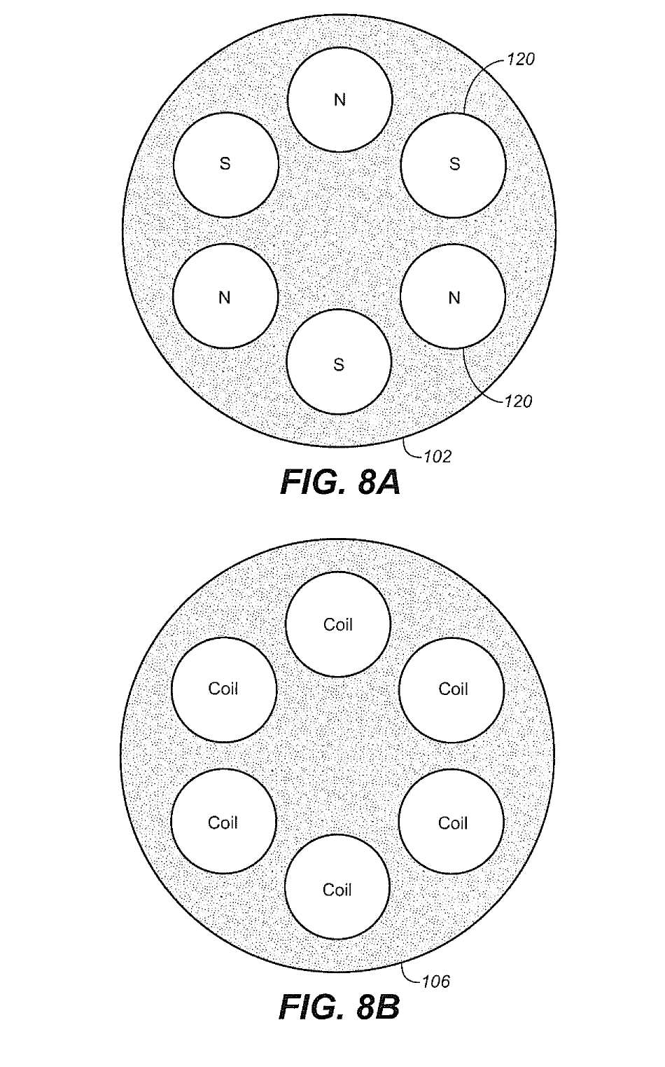

FIGS. 8A and 8B are schematic views of six permanent magnets and six coils distributed around a circle for illustrating one implementation of the embodiment of FIG. 7. As shown in FIG. 8A, the magnets 120 are arranged so that magnets with the North pole direction pointing out of the page marked “N” are separated by magnets whose North pole direction point into the page marked “S.” Preferably the six magnets are arranged in a circle on surface 104, and distributed so that they are substantially evenly spaced around the circle. The same is true for the coils 122 on surface 108 in FIG. 8B.

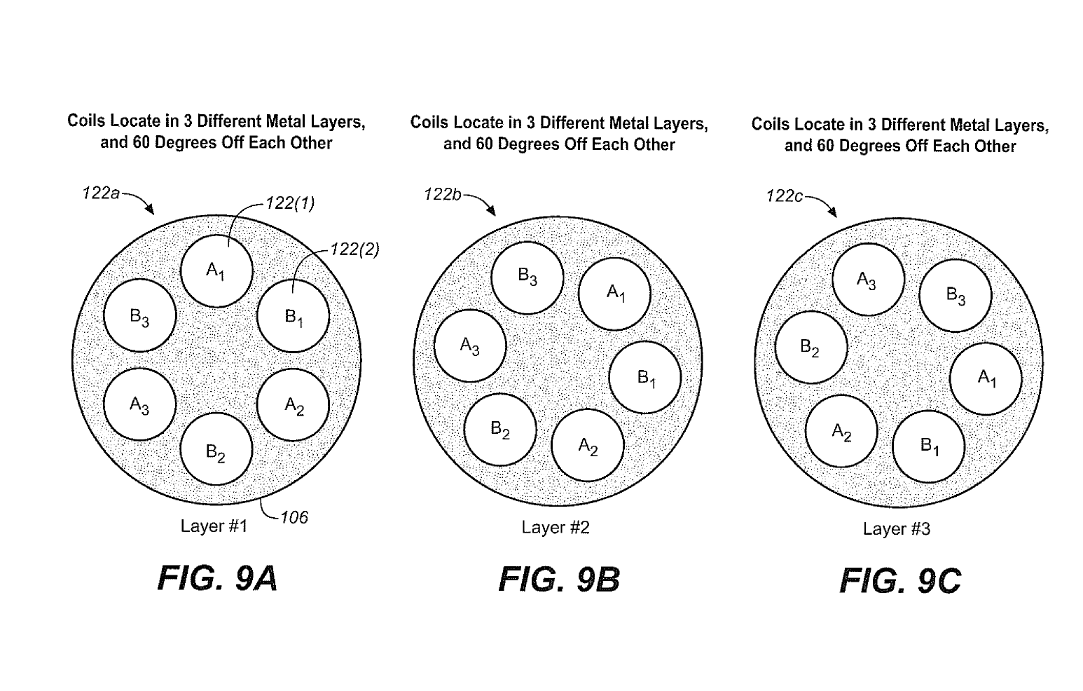

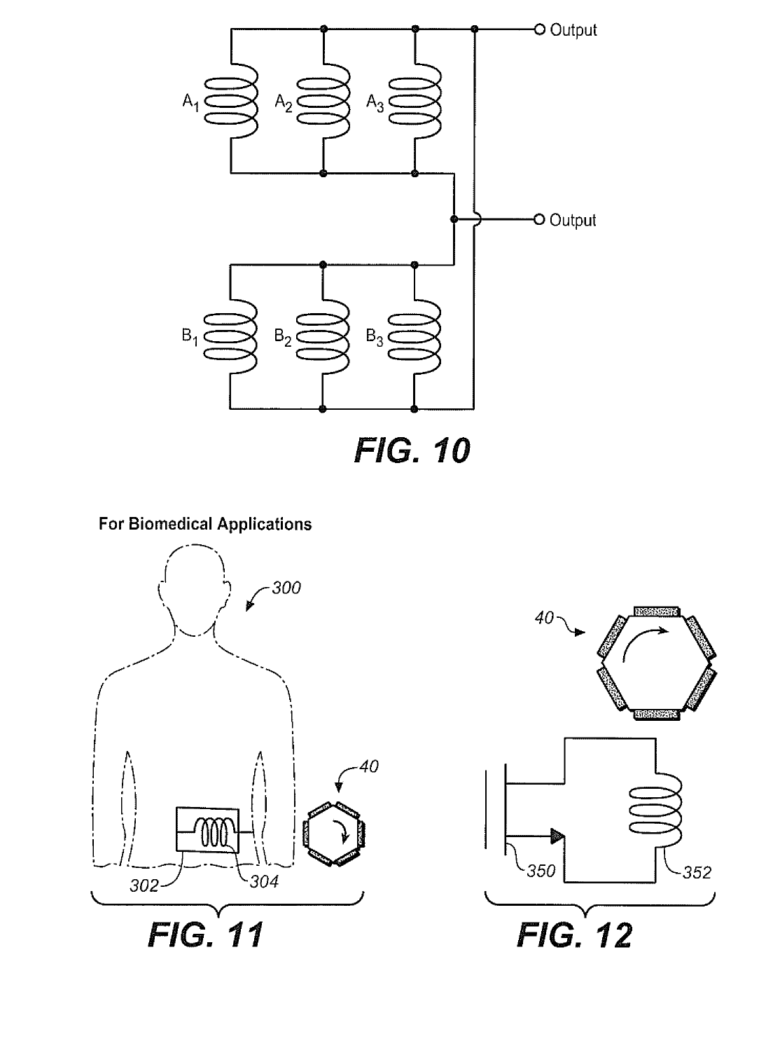

FIGS. 9A, 9B and 9C are schematic views of three layers of coils to be used as a modification of the scheme of FIG. 7 as shown in solid and broken lines to illustrate still another embodiment of the invention. Instead of only one layer 122a of coils as in FIGS. 7, 8A and 8B, two additional layers 122b and 122c of coils shown in phantom in broken lines in FIG. 7 are also employed. Thus, the six coils 122a mounted on surface 108 of plate 106 include three coils marked “A₁”, “A₂”, “A₃” that are separated from one another by one of the three coils marked “B₁”, “B₂” “B₃”, and the three coils marked“B₁”, “B₂” “B₃” that are separated from one another by one of the three coils marked “A₁”, “A₂”, “A₃”. The three coils marked “A₁”, “A₂”, A₃” are connected in parallel into a first group as shown in FIG. 10. The three coils marked“B₁”, “B₂” “B₃” are also connected in parallel into a second group as shown in FIG. 10. The two groups are connected in parallel but in opposite phase as shown in FIG. 10. This can be readily accomplished by connecting an end of the coil in the first group that is closer to the magnets than the other end of such coil to an end of the coil in the second group that is further away from the magnets than the other end of such coil. As shown in FIG. 10, the terminals 202 and 204 of the above described parallel connections of the first and second groups of coils provide a voltage output.

The coils in the second and third layers 122b, 122c are similarly spatially arranged as in layer 122a shown in FIGS. 8B, 9A, and are electrically connected as shown in FIG. 10. Thus, each of layers 122b and 122c also provides an output. The second layer 122b is oriented relative to layer 122a so that the corresponding coils marked “A₁”, “A₂”, “A₃” are rotated clockwise relative to coils marked “A₁”, “A₂”, “A₃” in layer 122a when viewed along the direction away from the magnets (e.g. viewing direction directed into the page in FIGS. 9A, 9B, 9C) by substantially 60 degrees. The coils “B₁”, “B₂” “B₃” in the second layer 122b are also rotated clockwise relative to coils marked“B₁”, “B₂” “B₃” in layer 122a when viewed along the direction away from the magnets (e.g. viewing direction directed into the page in FIGS. 9A, 9B, 9C) by substantially 60 degrees. Hence the output of layer 122b will be 60 degrees out of phase with the output of layer 122a. The third layer 122c is oriented so that the corresponding coils are rotated clockwise relative to those of layer 122b when viewed along the direction away from the magnets (e.g. shown as into the page in FIGS. 9A, 9B, 9C) by substantially 60 degrees, so that the output of layer 122c will be 60 degrees out of phase with the output of layer 122b. Hence, the combined outputs of layers 122a, 122b and 122c will provide a three phase output. As shown in FIG. 7, the coils in layers 122b and 122c may be embedded in plate 106.

FIG. 11 is a schematic view of a human body 300 with a medical device implant 302, which includes or is close to one or more coils 304 of the type described above, and one or more rotating permanent magnets (six are shown in FIG. 11 in assembly 40) to illustrate one application of one embodiment of the invention. Obviously any one of the combinations of magnets and coils described above, and variations thereof may be used for delivering power to the medical device implant may be used instead of the one shown in FIG. 11; such and other variations are within the scope of the invention.

Though one of the primary applications of the wireless power transfer is for biomedical implants, the application of the technology goes beyond medicine. The rotating-magnets based wireless power transfer method can be easily adapted by other electronic systems that cannot have batteries or wired power sources. In today's microelectronic circuit systems, the active devices are powered up by a battery and metal traces. However, in nanoelectronic circuit systems, the size of the nanoelectronic devices and the intended density of nanoelectronic circuit will make the traditional metal trace so tiny that the voltage or IR drop of each trace can be detrimental to the whole circuit system performance. To circumvent this issue, a distributed powering scheme is preferred in nanoelectronic circuit systems. Since the process technique of nano-scale coils (nano-spring) is available, a distributed powering scheme could be built based on the same wireless power transfer scheme. The nano-springs supply the power to the local nano size transistors. Ultra low frequency wireless power transfer based on the rotating-magnets is preferred because it has lower risk to interfere the operation of the nanoelectronic circuit system. This is illustrated in FIG. 12.

FIG. 12 is a schematic view of a nano-circuit such as a nano size transistor 350, a coil 352 adjacent to and connected electrically to the nano-circuit and one or more rotating permanent magnets (six are shown in FIG. 12) to illustrate another application of one embodiment of the invention. Obviously any one of the combinations of magnets and coils described above, and variations thereof may be used for delivering power to the medical device implant may be used instead of the one shown in FIG. 12; such and other variations are within the scope of the invention.

While the invention has been described above by reference to various embodiments, it will be understood that changes and modifications may be made without departing from the scope of the invention, which is to be defined only by the appended claims and their equivalents. For example, while the permanent magnet or permanent magnets are described as rotated relative to the one or more coils, wireless power may be delivered by linearly moving the permanent magnet or permanent magnets relative to the one or more coils, or by a combination of linear motions in different directions, in a way that will cause the magnetic flux passing through the one or more coils to change, such as by means of a gear mechanism. Wireless power may also be delivered by a combination of linear and rotational relative motions between the permanent magnet or permanent magnets relative to the one or more coils by means of a gear mechanism in combination with a motor. Such and other variations are within the scope of the invention.

What is claimed is:

1. An apparatus for supplying power to a medical device to be implanted in a living being, comprising:
a coil located in or near said medical device, said coil having an axis;
at least one permanent magnet located adjacent to said coil; and
a mechanism for moving said at least one permanent magnet relative to the coil to induce a current in the coil.

2. The apparatus of claim 1, said mechanism comprising a motor for rotating said at least one permanent magnet about a line.

3. The apparatus of claim 2, wherein said line is substantially parallel or perpendicular to said axis.

4. The apparatus of claim 2, said apparatus comprising a plurality of permanent magnets, said apparatus further comprising a polygonal rotor supporting said plurality of permanent magnets, wherein said motor rotates said rotor about said line.

5. The apparatus of claim 3, wherein said polygonal rotor has an even number of sides.

6. The apparatus of claim 4, wherein said polygonal rotor is hexagonal.

7. The apparatus of claim 2, wherein rotation of said at least one permanent magnet induces a current in the coil having a frequency of not more than 1 KHz.

8. The apparatus of claim 2, said apparatus comprising a plurality of permanent magnets supported on a substantially planar surface of a rotor and with axes aligned substantially parallel to said line, wherein said motor rotates said rotor about said line, said apparatus further comprising a plurality of coils arranged with their axes substantially parallel to said line and in close proximity to said permanent magnets.

9. The apparatus of claim 8, wherein said number of coils is equal to the number of said permanent magnets, and said coils are distributed in a manner similar to distribution of said permanent magnets on said substantially planar surface.

10. The apparatus of claim 8, wherein said permanent magnets are arranged along a circle on said substantially planar surface, with adjacent ones of the said permanent magnets around the circle oriented with opposite polarities.

11. The apparatus of claim 10, said apparatus comprising six permanent magnets are arranged along a circle on said substantially planar surface with adjacent ones of the said permanent magnets around the circle oriented with opposite polarities.

12. The apparatus of claim 11, said apparatus comprising three groups of six coils each arranged angularly evenly spaced apart along a circle with their axes substantially parallel to said line and in three corresponding layers substantially parallel to said substantially planar surface.

13. The apparatus of claim 12, wherein each of the three groups of coils comprises a first and a second sub-group, each including three coils that are separated by another coil that is not in such sub-group, said apparatus further comprising connections electrically connecting the coils, so that for each of the three layers of coils, the coils in the first sub-group are electrically connected in parallel and the coils in the second sub-groups are electrically connected in parallel where the two sub-groups are connected in parallel but in opposite phase to provide an output, wherein the first sub-groups in the three layers being angularly displaced from one another by 60 degrees, and the second sub-groups in the three layers being angularly displaced from one another by 60 degrees, so that the outputs of the three groups of coils provide a three phase electrical current output.

14. The apparatus of claim 1, further comprising a ferrite core in said coil.

15. The apparatus of claim 14, further comprising a back plate adjacent to said core.

16. The apparatus of claim 1, wherein a diameter of said coil is greater than the largest dimension of said at least one permanent magnet.

17. An apparatus for supplying power to a nano-electronic circuit, comprising:
a coil located adjacent to said nano-electronic circuit, said coil having an axis;
at least one permanent magnet located adjacent to said coil; and
a mechanism for moving said at least one permanent magnet relative to the coil to induce a current in the coil.

18. A method for supplying power to an electronic device, said device comprising a coil located in said device, said coil having an axis, said method comprising:
providing at least one permanent magnet located adjacent to said coil; and
moving said at least one permanent magnet relative to the coil to induce a current in the coil.

19. The method claim 18, said moving including rotating said at least one permanent magnet about a line.

20. The method claim 19, wherein said line is substantially parallel or perpendicular to said axis.

21. The method claim 19, wherein rotation of said at least one permanent magnet induces a current in the coil having a frequency of not more than 1 KHz.
